(19) United States
(12) Patent Application Publication
(10) Pub. No.: US 2026/0158368 A1
(43) Pub. Date: Jun. 11, 2026

(54) INTERNALLY LIT, TRANSPARENT, LIGHTWEIGHT, AND HIGH-SPEED PINBALL

(71) Applicant: Timothy Daniel O'Blenis, Greely (CA)

(72) Inventor: Timothy Daniel O'Blenis, Greely (CA)

(21) Appl. No.: 19/397,440

(22) Filed: Nov. 21, 2025

Related U.S. Application Data
(60) Provisional application No. 63/728,835, filed on Dec. 6, 2024.

(51) Int. Cl. A63F 7/40; A63F 7/02; F21V 23/00; F21V 33/00

(52) U.S. Cl. CPC A63F 7/40; A63F 7/025; F21V 23/003; F21V 33/008; A63F 2007/4043

(57) ABSTRACT

The present invention introduces a new type of pinball that contains an internal lighting circuit and lights up from the inside when struck or signalled to do so. The new pinballs'internal lighting features provide a more visually dynamic and engaging appearance than standard pinballs made of steel, with the colors and lighting effects of the new pinball being better able to support the themes and storylines of pinball machines than standard pinballs can. The new pinball can be produced with a weight lighter than standard pinballs, which offers functional advantages in terms of faster gameplay and responsiveness of the new pinball when compared with standard pinballs. The new pinball can be used as a main playfield or captive pinball in most existing pinball machines, replacing standard pinballs, and with new or specially designed machines that take further advantage of the new pinballs'unique properties.

### CROSS-REFERENCE TO RELATED APPLICATIONS

This application claims the benefit of U.S. Provisional Patent Application No. 63/728,835 of the same Title filed Dec. 6, 2024. Confirmation No. 7865. Filing Receipt *OC000000081864035*

### BACKGROUND OF THE INVENTION

The present invention relates generally to pinball machines, and more specifically pertains to a new type of pinball (the ‘new pinball’) that lights up from the inside when struck or signalled to do so.

Pinball machines have been a popular form of entertainment for decades, with the primary objective being to launch and control a pinball through various obstacles and targets on the pinball machine playfield. Standard pinballs are most often made of steel and provide a reflective, but otherwise static, appearance during gameplay. While pinball machines themselves have evolved to include new and different lighting and visually engaging effects that support the themes and storylines of the pinball machines, most pinball machines still use standard pinballs. These standard pinballs are not internally lit and are not dynamic in terms of their appearance. As such, there exists an opportunity for a new pinball that is more visually engaging and better able to support the themes and storylines of pinball machines.

### SUMMARY OF THE INVENTION

The new pinball is characterized by its use of a battery-powered lighting circuit inside the new pinball. This lighting circuit activates to display different colors and lighting effects when the new pinball is struck, or when it receives a remote signal to do so. This provides a more visually dynamic and engaging appearance than standard pinballs, with the colors and lighting effects of the new pinball being better able than standard pinballs to support the themes and storylines of the pinball machines. The new pinball can also be made lighter than standard pinballs by adjusting the type or amount of ballast material used during production, supporting faster pinball movement and gameplay. The new pinball contains ballast material, such as tungsten alloy, and an electronic circuit for powering, activating and controlling the lighting. The new pinball also contains durable transparent or translucent material, such as a hybrid resin. Once cured, the resin fixes the lighting circuit and ballast material in place and provides a hard and smooth outer surface, while also allowing the lighting inside the new pinball to shine out onto the pinball machine playfield. This invention can be used in pinball machines that use standard 1 1/16″ (27 mm) diameter spherical steel pinballs weighing approximately 2.8 ounces (80 grams). This invention can also be produced with custom diameters and weights.

### BRIEF DESCRIPTION OF THE DRAWING

FIG. 1 Front view showing the transparent or translucent outer sphere layer 10, inner sphere 11, and lighting 20.

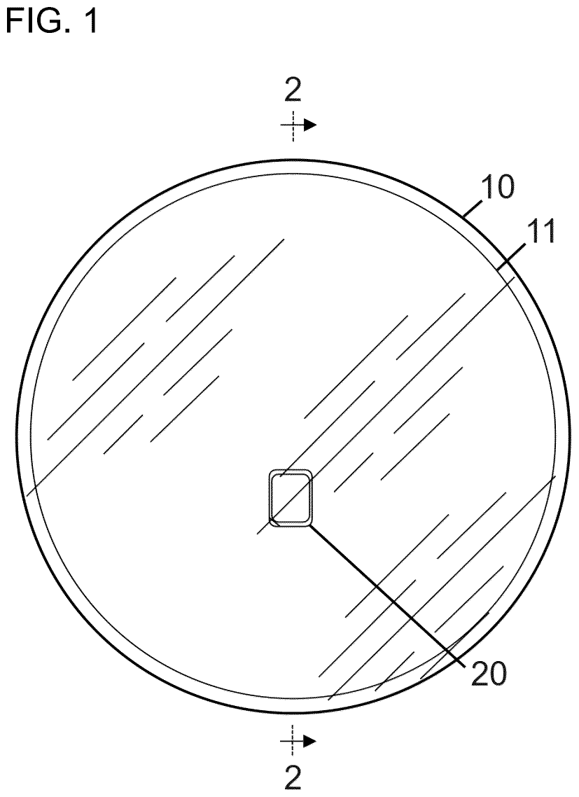

FIG. 2 Cross-sectional side view of the full diameter centerline of the new pinball, showing the components of a single resistor 17 and single light 20 configuration.

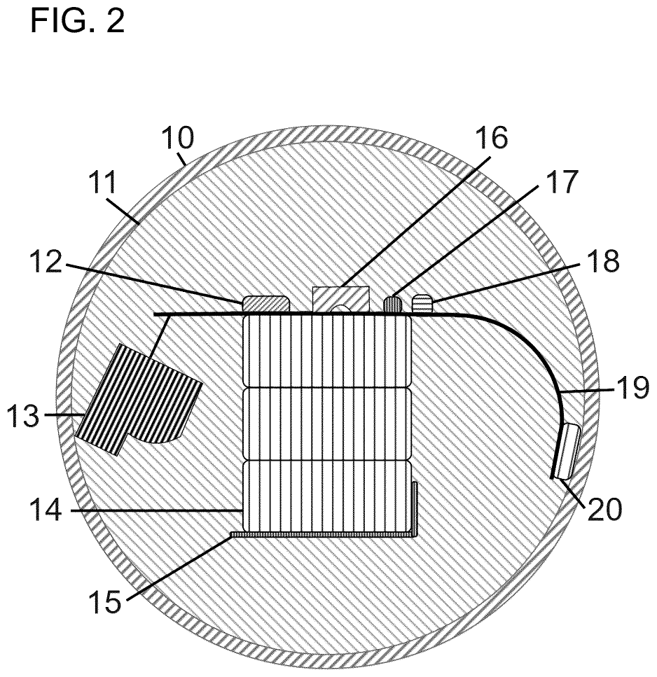

### DETAILED DESCRIPTION OF THE INVENTION

The new pinball is made of a 1 mm thick transparent or translucent, impact-resistant resin polymer outer sphere layer 10. This outer sphere layer 10 creates a hard and smooth 27 mm diameter outer sphere which encases a 25 mm diameter inner sphere 11. The inner sphere 11 encases the lighting circuit of the new pinball in a mixture of resin and ballast material, such as epoxy and tungsten alloy. Inside the inner sphere 11, a flexible printed circuit board 19 connects all the lighting circuit components of the new pinball. These components include a battery pack 14, which powers the circuit. The battery pack 14 can be non-rechargeable or rechargeable and is connected to the circuit and held in position by a battery-holder 15. A normally open vibration sensor switch 12 closes when it detects strong impacts like collisions between the new pinball and targets on the pinball machine playfield or other pinballs. This triggers the microcontroller 16, to activate one or more lights 20, in one or more preprogrammed lighting display sequences, such as fading in and out. The microcontroller 16 power stabilization and transient current supply needs are supported by a decoupling capacitor 18. The lights 20 are protected from excess current by one or more resistors 17, with the type and number of resistors 17 used being based on the number and type of lights 20 used. A single resistor and single light configuration is shown in this submission. An optional receiver 13 can be included in the lighting circuit to allow for activation of the lighting 20, changes in the lighting color, or changes in lighting display sequences, based on remote signals, such as infra-red signals. These remote signals are received from a transmitter controlled by the player, operator (machine owner or venue owner), or from the pinball machine itself.

Suitable primary materials for the inner sphere 11 and outer sphere layer 10 include synthetic resins that offer the properties of high durability, transparency or translucency, and a smooth exterior finish, such as polyurea, polyurethane, epoxy, or a mixture of these materials. These materials are applied using spherical molds to form the 25 mm inner sphere 11 which, once cured in a pressure tank to remove bubbles from the resin, is then encased in the 27 mm outer sphere using a 27 mm mold, which is also cured in a pressure tank. The amount and type of ballast material used allows the new pinball to be heavy enough to not become stuck while activating targets in the pinball machine, while also being light enough to allow for ball loading, plunging, and other standard pinball machine functions to occur normally—as they would with a standard pinball weighing approximately 80 grams. Note that, in its'standard configuration, the new pinball uses tungsten alloy as the main ballast material. As such the new pinball is weakly magnetic. This means the new pinball will not react the same way as steel pinball do to magnetic devices in pinball machines, nor will the new pinball magnetize over time.

All the components of the new pinball should be positioned such that their combined center of gravity is located at the geometric center of the overall 27 mm sphere. This helps minimize wobble in the new pinball when it rolls.

In its'standard configuration the new pinball has a diameter of approximately 1 1/16 inches (27 mm) which is the diameter of standard pinballs used in most pinball machines. The new pinball can also be produced with different diameters.

In its'standard configuration the new pinball has a weight of approximately 80 grams, which is the approximately the same weight as a standard pinball. Custom versions of the new pinball can be made heavier, or lighter than the weight of a standard pinball if required. Increased weight is achieved by using more, or higher density, ballast material. Reduced weight is achieved by using lower density, or less, ballast material. Reduced weight leads to faster gameplay, enhancing the gaming experience by allowing for faster pinball movement and interaction with pinball machine features. Very light versions of the new pinball, under 60 grams, are best suited for specific uses, such as for captive balls which only move within a fixed portion of pinball machine playfields. This is because very light new pinballs risk failing to activate some pinball machine playfield targets or getting stuck when trying to activate some pinball machine playfield targets, if the new pinballs are too light.

The new pinball can be produced in a variety of colors by changing the fixed color of the internal lights 20, using multiple lights 20 of different colors, using programmable multicolor lights 20 controlled by the microcontroller 16 to achieve a full spectrum of colors, by incorporating dyes or pigments directly into the resin material, by using different color ballast material, or by coating the surface of the inner sphere 11 or outer sphere layer 10 with a thin, durable color layer. These new pinball color options may be solid, gradient, or otherwise combined, allowing for customization based on player, operator, or pinball machine manufacturer preferences.

Lighting sequences for the new pinball can be any sequence of any duration that is programmable into the microcontroller 16 and supportable by the lighting 20 and battery pack 14. Lighting sequence options for the new pinball include, but are not limited to, sequences that resemble breathing or other fading, lightning, fire, explosions, strobe lights, as well as flickering, flashing or chasing lights.

1. A new pinball that is more visually engaging and better able to support the themes and storylines of pinball machines than standard pinballs by lighting up from the inside when struck or signalled to do so, comprising:
A smooth finished 27 mm diameter outer sphere made of durable transparent or translucent material that is resistant to damage from collisions with other objects, attached to and encasing a 25 mm diameter inner sphere;
A 25 mm diameter inner sphere made of resin and ballast material, encasing the internal lighting circuit of the new pinball;
An internal lighting circuit that includes a power source, such as a battery pack, vibration sensor switch, microcontroller, lighting, resistors and capacitors, connected in a circuit that activates a lighting sequence inside the new pinball when the new pinball collides with other objects; and
Microcontroller programming and lightning options that allow the new pinball to display a full spectrum of colors and a wide variety of lighting sequences, including but not limited to solid colors, gradient colors, fire effect lighting, lightening effect lighting, explosion effect lighting, fading and breathing effect lighting, flashing lighting, flickering lighting, chasing lighting, or custom-programmed effects.

2. The new pinball of claim 1, wherein the power source can be non-rechargeable or rechargeable.

3. The new pinball of claim 1, wherein an optional receiver can be included in the internal lighting circuit to allow for changes in the color and lighting display sequences based on signals received from a remote transmitter.

4. The new pinball of claim 1, wherein the new pinball standard configuration size and weight approximate those of a 1 1/16″ diameter, 2.8 ounce standard steel pinball, with the dimensions and weight of the new pinball being customizable during production, including the production of new pinballs that are lighter and faster moving than standard pinballs.
